(19) United States
(12) Patent Application Publication
(10) Pub. No.: US 2002/0119232 A1
(43) Pub. Date: Aug. 29, 2002

(54) Co-processed emulsifier /carrier systems for full-fat farinaceous baked goods

(76) Inventors: Andrew J. Grazela, San Diego, CA (US); Neil Argo Morrison, San Diego, CA (US); Ofori J. Amankonah, San Diego, CA (US); Gerald Coleman, (US)

Correspondence Address: SUSAN A. WOLFFE, BANNER & WITCOFF, LTD., 1001 G ST., N.W., WASHINGTON, DC, 20001, US

(21) Appl. No.: 09/982,998

(22) Filed: Oct. 22, 2001

Related U.S. Application Data
(60) Provisional application No. 60/242,439, filed on Oct. 24, 2000.

(51) Int. Cl. A21D 10/00

(52) U.S. Cl. 426/555

(57) ABSTRACT

Emulsifiers are co-processed with a carrier to produce a fine powder. The fine powder is added to the dry mix portion of full-fat baked good formulations, such as full-fat yellow layer cake formulations. Compared to the addition of dry dairy protein and powdered emulsifiers separately, batter aeration is enhanced, cake volume is increased, a finer and more even crumb structure with softer texture is produced, and storage qualities are improved.

This application claims priority to provisional U.S. Application Ser. No. 60/242,439, filed Oct. 24, 2000, which is hereby incorporated by reference in it's entirety.

### FIELD OF THE INVENTION

The present invention relates to co-processed emulsifier/carrier system for farinaceous baked goods.

### BACKGROUND OF THE INVENTION

Emulsifiers or surfactants are used extensively in farinaceous baked goods to improve product volume, tenderize crumb, slow the rate of crumb firming, etc. Such emulsifiers or surfactants are also known in the farinaceous baked goods industry as crumb softeners, anti-staling agents, dough conditioners, and the like. Hereinafter, the term emulsifier will be used to represent both emulsifiers and surfactants.

The mechanism for emulsifier functionality is well-known and is related to the amphiphilic character and resulting surface activity of the emulsifier. The use of emulsifiers in specific applications is guided not only by the hydrophilic-lipophilic balance (HLB) of the emulsifier, but also by the handling characteristics conferred by its physical form (e.g., plastic, powdered, beads, flakes). Thus, as proper dispersion of the emulsifier is crucial to its ability to function in an application, the baking industry generally uses plasticized shortening-like emulsifiers, pre-hydrated paste-like emulsifiers, fine powdered emulsifiers (especially in dry mixes), or some combination of these, for ease of processing. (See, for example, Pyler, E. J. 1988. Baking Science & Technology, 3^{rd} ed. Sosland Publishing Company, Merriam, Kans.)

It is desirable to produce an emulsifier system that enhances batter aeration, increases cake volume, produces a finer and more even crumb structure with softer texture, and improves storage qualities.

### BRIEF SUMMARY OF THE INVENTION

The present invention is directed to emulsifiers that are co-processed with a carrier to produce a fine powder. The fine powder is added to the dry mix portion of full-fat baked good formulations, such as full-fat yellow layer cake formulations.

Compared to the addition of dry dairy protein and powdered emulsifiers separately, the co-processed emulsifier/carrier formulation provides enhanced batter aeration, increased cake volume, a finer and more even crumb structure with softer texture, and improved storage qualities. In addition, manufacturers can reduce the number of ingredient additions in a manufacturing process, reduce the number of ingredients required to be stocked, and produce higher-value finished goods with longer shelf-life. Further, the final products are more aesthetically pleasing and have better eating and keeping qualities.

The present invention is directed to a full-fat baked good composition comprising a full-fat baked good dry mixture, an emulsifier, and a carrier, wherein the emulsifier and carrier are commingled to enhance the emulsifier performance in the prepared full-fat baked good. The present invention is particularly directed to a composition comprising an emulsifier selected from propylene glycol monoesters, monoglycerides, and sodium stearoyl lactylate and a carrier selected from microparticulated whey protein concentrate.

The emulsifier and carrier may be co-processed by spray-drying, co-drying, co-solution, co-precipitation, encapsulation, co-melting, co-milling, homogenization, or any other process involving salvation, heat, pressure and/or shear to bring about intimate commingling of the components.

The present invention is also directed to a method for introducing an emulsifier into a dry mixture to produce a baked good. The method improves the dispersibility of emulsifier and improves its functionality.

### DETAILED DESCRIPTION OF THE INVENTION

It was discovered that enhanced functionality of an emulsifier in a full-fat baked good is achieved by improving dispersion of the emulsifier in the baked good matrix. It was further discovered that improved dispersion is achieved if the emulsifier is co-processed with a suitable carrier prior to addition to the dry mixture of a full-fat baked good mix.

In accordance with the invention, the emulsifier/carrier is introduced into a full-fat baked good mix, such as cake mixes, in such as manner to improve the dispersibility of the emulsifier and to improve its functionality over current state-of-the-art. The emulsifier/carrier is introduced and mixed into the dry ingredients. After the dry ingredients are mixed, the dry ingredients may be packaged for storage or the requisite wet ingredients, e.g. oil, eggs, water, to prepare the baked good may be added.

The emulsifier/carrier combination is known for use in low fat baked good mixtures as a fat replacement. In the instant invention, the emulsifier/carrier combination is not used as a fat replacement but instead is used in full-fat recipes to improve dispersibility of the emulsifier.

Full-fat recipes provide a product having 6 wt % or more fat. Low fat cake recipes generally have about 3 g of fat per 50 g of product or up to about 3 wt % fat. Full-fat baked good mixtures in accordance with the invention include cakes mixes, pie crusts, muffins, brownies, pastries, sweet doughs, and breads, which are sold in dry mix form from grocery stores, for example.

The emulsifier and the carrier are first co-processed to form a fine powder, that is, particles smaller than 200 mesh. This fine powder is then added to dry ingredients of a baked good mix.

Effective amounts of the emulsifier are used to provide, for example, the desired product volume, tenderized crumbs, and desired rate of crumb firming. The amount of the emulsifier is within the skill of the art, but is typically 0.05% to 5%, preferably 0.25% to 2.5%, based on the total weight of the formulation. It is noted that the upper levels of many emulsifiers are self-limiting due to detrimental effects from over-emulsifying (see Pyler, E. J.). In addition, many emulsifier levels are regulated in various countries (e.g., in the United States by Code of Federal Regulations #21.)

Effective amounts of the carrier are used to provide the desired dispersibility of the emulsifier as well as improve its functionality. As the carrier can be selected from either minor ingredients (e.g., salts, hydrocolloids, protein sources) or major ingredients (e.g., sugar, flour), the amount of the carrier can range from 0.05 to 75 wt % based on the total formulation weight, though preferably is from 0.5 to 5 wt %.

The ratio of emulsifier to carrier is typically 1500:1 to 1:100, preferably 15:1 to 1:1.

The co-processing method must be adequate to commingle the emulsifier and carrier. Commingling means attachment of the emulsifier to the carrier, and/or partial or complete coating of the carrier with emulsifier (or vice-versa) and/or partial or complete encapsulation of the carrier by emulsifier (or vice-versa). Commingling is a more intimate proximity between the emulsifier and carrier than simple dry-blending can achieve. Suitable methods include, but are not limited to, one or more of: spray-drying, co-drying, co-solution, co-precipitation, encapsulation, co-melting, co-milling, homogenization, or any other process involving solvation, heat, pressure and/or shear to provide intimate commingling of the components. Preferably the co-processing method is spray-drying.

The emulsifier may be, but is not limited to, one or more of: lecithins; mono- and diglycerides such as succinylated monoglycerides, ethoxylated mono- and diglycerides, acetylated monoglycerides, acetoglycerides, lactylated monoglycerides and citric acid esters of monoglycerides; polyglycerol esters; polyhydric alcohol esters such as propylene glycol mono- and diesters of fatty acids and polysorbates; diacetyl tartaric acid esters of fatty acids such as DAT, DATA, TEM, DATEM which are all commonly used abbreviations for diacetyl tartaric acid esters of monoglycerine; acyl lactylates such as salts of stearoyl-2-lactylates (SSL); and stearoyl fumarates. Preferably, the emulsifier is least one of propylene glycol monoesters, monoglycerides, and sodium stearoyl lactylate.

The carrier may be, but is not limited to, one or more of: dried dairy products such as nonfat dry milk (NFDM), dry part-skimmed milk, dry whole milk, caseins, caseinates, whey proteins, dry sweet whey, dry acid whey, reduced-lactose whey, reduced-minerals whey, whey protein concentrates (WPC), whey protein isolates, microparticulated whey protein concentrates and lactose; wheat and grain products and components of such products such as flours, native and/or modified starches, glutens, dextrins and maltodextrins; sugars such as sucrose, dextrose, fructose and glucose syrup solids; proteins such as dried whole egg, dried egg white, dried egg yolk and egg yolk proteins and soy proteins; thickeners; hydrocolloids; and gums including biosynthetic gums such as xanthan gum and gellan gum; pectins, galactomannans and seed and exudate gums such as gum arabic, guar gum and locust bean gum; cellulose gels and gums such as carboxymethylcellulose (CMC) and modified gellulose gels and gums; seaweed-derived products such as agars, carrageenans and alginates including modified alginates such as propylene glycol alginate (PGA); edible salts such as sodium chloride, calcium chloride, trisodium citrate, and calcium lactate; food acidulants such as citric acid, malic acid, adipic acid, and lactic acid; and preservatives such as sodium benzoate, potassium sorbate, and calcium propionate. Preferably, the carrier is microparticulated whey protein concentrate. glycol monoesters, monoglycerides, and sodium stearoyl lactylate, and a microparticulated whey protein concentrate. Suitable emulsifier/carrier systems are manufactured by CP Kelco Company and sold under the SIMPLESSE 700 series e.g.

SIMPLESSE 720. The SIMPLESSE 700 series is sold as fat substitutes in low fat baked goods and are a microparticulated whey protein concentrate, emulsifier blend.

The present invention is also directed to a method for introducing an emulsifier into a baked good which improves the dispersibility of emulsifier over the current state-of-the-art and, ultimately, improves its functionality. In particular, a suitable emulsifier is commingled with a carrier and then the emulsifier/carrier are added to the dry ingredients of a cake mix, or other baked product dry mixture.

### EXAMPLES

### Example 1

| | Control | Control | Inventive | Inventive |
|---|---|---|---|---|
| Ingredient | Bakers' % | True % | Baker's % | True % |
| Sugar | 140 | 30.5 | 143 | 31.2 |
| Cake flour | 100 | 21.8 | 100 | 21.8 |
| Whey protein | 12 | 2.6 | — | — |
| concentrate | | | | |
| Simplesse 720 | — | — | 12 | 2.6 |
| Dried whole | 9 | 2.0 | 9 | 2.0 |
| eggs | | | | |
| Baking | 6 | 1.3 | 6 | 1.3 |
| Powder | | | | |
| Salt | 3 | 0.7 | 3 | 0.7 |
| Emulsifier, | 3 | 0.7 | — | — |
| powdered | | | | |
| Xanthan gum | 0.5 | 0.1 | 0.5 | 0.1 |
| Shortening | 50 | 10.9 | 50 | 10.9 |
| Water | 135 | 29.4 | 135 | 29.4 |

Simplesse 720 is a microparticulated whey protein product containing an emulsifier.

Eight-inch, tall-form cake pans were lined with release paper and sprayed lightly with vegetable oil. All of the dry ingredients were added to a mixer bowl and blended with a paddle attachment for three minutes at low speed. Shortening was added and then 60% of the water. The ingredients were mixed for 0.5 minute at low, and then mixed for four minutes at medium. Half of the remaining water was added and then the ingredients were mixed 0.5 minute at low, and then 2 minutes at medium. The remaining water was added and then the ingredients were mixed 0.5 minute at low, and then 2 minutes at medium. 425 g batter was poured into each cake pan and baked at 375° F. until done (approximately 30 minutes). The cakes were cooled on rack for 15 min before depanning.

Results

| Parameter | Control | | Invention | | Change |
|---|---|---|---|---|---|
| Batter viscosity | 62,000 | cp | 80,000 | cp | +29% |
| Batter density | 0.83 | g/cc | 0.69 | g/cc | −17% |
| Volume index | 121 | | 149 | | +23% |
| Cell fineness | 770 | | 910 | | +18% |
| Molding errors | 29% | | 13% | | −55% |
| TPA hardness 1-day storage | 920 | g | 590 | g | −36% |
| TPA hardness 7-day storage | 2500 | g | 1600 | g | −36% |

Volume index determined by AACC test method 10-91; Cell fineness determined by AIB Crumbscan testing; Molding errors determined by AIB Crumbscan testing

The results show an increase in batter viscosity, volume index, and cell fineness, and a decrease in batter density. TPA hardness values obtained with a TA-XT2 texture analysis from Texture Technologies, Inc. There was a decrease in the degree of crumb firming over time.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A full-fat dry baked good mixture composition comprising a full-fat dry mixture, and at least one emulsifier and carrier, wherein the emulsifier and carrier are co-processed prior to addition to the dry mixture.

2. The composition of claim 1 wherein the emulsifier is selected from the group consisting of lecithins; mono- and diglycerides; polyglycerol esters; polyhydric alcohol esters; diacetyl tartaric acid esters of fatty acids; acyl lactylates and stearoyl fumarates.

3. The composition of claim 1 wherein the emulsifier is selected from the group consisting of succinylated monoglycerides, ethoxylated mono- and diglycerides, acetylated monoglycerides, acetoglycerides, lactylated monoglycerides, and citric acid esters of monoglycerides.

4. The composition of claim 1 wherein the emulsifier is selected from the group consisting of propylene glycol monoesters, monoglycerides, and sodium lactylates.

5. The composition of claim 1 wherein the emulsifier is selected from the group consisting of propylene glycol mono- and diesters of fatty acids polysorbates, diacetyl tartaric acid esters of monoglyceride, and salts of stearoyl-2-lactylates.

6. The composition of claim 1 wherein the carrier is selected from the group consisting of dried dairy products; wheat and grain products and components thereof; sugars; proteins; thickeners; hydrocolloids; and gums.

7. The composition of claim 6 wherein the carrier is selected from the group consisting of nonfat dry milk, dry part-skimmed milk, dry whole milk, caseins, caseinates, whey proteins, dry sweet whey, dry acid whey, reduced-lactose whey, reduced-minerals whey, whey protein concentrates, microparticulated whey protein concentrates and lactose.

8. The composition of claim 6 wherein the carrier is selected from the group consisting of flours, native or modified starches, glutens, dextrins, maltodextrins; sucrose, dextrose, fructose, glucose syrup solids; dried whole egg, dried egg white, dried egg yolk and egg yolk proteins and soy proteins.

9. The composition of claim 6 wherein the carrier is selected from the group consisting of xanthan gum; gellan gum; pectins, galactomannans gum arabic, guar gum and locust bean gum; cellulose gels and carboxymethylcellulose; modified gellulose gels and gums; agars, carrageenans and alginates.

10. The composition of claim 6 wherein the carrier is a microparticulated whey protein concentrate.

11. The composition of claim 1 wherein the amount of the emulsifier is about 0.05 to 5 wt % based on total weight of the dry ingredients and the amount of the carrier is 0.05 to 75 wt %, based on total weight of the dry ingredients.

12. The composition of claim 11 wherein the amount of the emulsifier is about 0.25 to 2.5 wt %, based on total weight of the dry ingredients.

13. The composition of claim 11 wherein the amount of the carrier is 0.5 to 5 wt %, based on total weight of the dry ingredients.

14. The composition of claim 1 wherein ratio of emulsifier to carrier is about 1500:1 to 1:100.

15. The composition of claim 14 wherein ratio of emulsifier to carrier is about 15:1 to

16. A method of preparing a full-fat dry mixture composition comprising an emulsifier and a carrier, wherein the method comprises co-processing the emulsifier and carrier, and then adding the co-processed emulsifier and carrier to the full-fat dry mixture.

17. The method of claim 16 wherein the commingling comprises at least one method selected from the group consisting of spray-drying, co-drying, co-solution, co-precipitation, encapsulation, co-melting, co-milling, and homogenization.

18. The method of claim 17 wherein the commingling comprises spray-drying.
